(19) United States
(12) Patent Application Publication
(10) Pub. No.: US 2016/0183512 A1
(43) Pub. Date: Jun. 30, 2016

(54) MOSQUITO-KILLING SCREEN WINDOW

(71) Applicant: YU SHING CHAN, Ma On Shan (HK)

(72) Inventor: YU SHING CHAN, Ma On Shan (HK)

(21) Appl. No.: 14/918,581

(22) Filed: Oct. 21, 2015

(30) Foreign Application Priority Data
Dec. 30, 2014 (HK) 14113060.2

(51) Int. Cl. A01M 1/22; E06B 9/52

(52) U.S. Cl. CPC A01M 1/223; E06B 9/52; E06B 2009/524; E06B 2009/527

(57) ABSTRACT

The present invention discloses a mosquito-killing screen window, including a frame body (1) and a mosquito-killing window sash (2), wherein the mosquito-killing window sash (2) is disposed in the frame body (1) and can slide in the same, the inside of the frame body (1) is fixedly provided with a first energizing part (3) and the first energizing part (3) is connected to a power source through a wire, the wire is disposed in the frame body (1), the mosquito-killing window sash (2) is fixedly provided with a second energizing part (4), the second energizing part (4) is connected to a mosquito-killing mesh (21) of the mosquito-killing window sash (2), and the first energizing part (3) is matched with the second energizing part (4) so that the first energizing part (3) is communicated with the second energizing part (4) when closing the window. The window provided by the present invention is beautiful in entirety, has high security performance and saves energy.

### TECHNICAL FIELD

The present invention belongs to the technical field of mosquito-killing, and particularly relates to a mosquito-killing screen window.

### BACKGROUND

Mosquito is one of vector insects that mainly spread such transmissible diseases as epidemic encephalitis B, paludism, filariasis, Singapore hemorrhagic fever and the like. The mosquito not only spreads transmissible diseases, but also brings trouble to people's life when biting people.

In order to solve the trouble brought by the mosquito, the most common method used at present is to realize mosquito repelling through lighting a mosquito-repellent incense. But the smoke produced during the burning of the mosquito-repellent incense includes harmful substances to a human body, which will cause injury to the human body while repelling the mosquito.

Later, there is an electronic mosquito-killing racket in the market, which is favored by people due to its advantages like utility, good mosquito-killing effect, no chemical contamination, safety and healthfulness, and the like.

Still later, there is a mosquito-killing screen window in the market, which is installed on doors and windows, and includes three layers of metal mosquito-killing meshes, wherein an insulating frame is disposed between two adjacent layers of mosquito-killing meshes, the metal mosquito-killing mesh in the middle is an anode, and the other two layers of the metal mosquito-killing meshes are cathodes. The metal mosquito-killing mesh is connected to a wire, and a plug is disposed at the other end of the wire. When a mosquito-killing device works, the plug is inserted into a socket for energizing to supply power to the metal mosquito-killing mesh through an alternating current.

However, since a power wire needs to be externally connected to the AC socket, the connection process is time-consuming and tedious; if the power source socket is too far away from the screen window, the power wire needs to follow the screen window while the screen window is opened and closed; moreover, the power wire is always in a suspension state, which is inconvenient to use; in addition, the beauty will be reduced greatly, and connection of the AC power source also brings hidden dangers to the safety of person. The screen window is always in an energizing state no matter it is opened or closed, and is still energized when the screen window is opened and energizing is not needed, thus wasting the electric energy.

Therefore, it is an urgent issue for those skilled in the art to provide a mosquito-killing screen window which is beautiful in entirety, has high security and can save energy.

### SUMMARY

In light of this, the object of the present invention is to provide a mosquito-killing screen window which is beautiful in entirety, has high security and can save energy.

To fulfill the foregoing object, the present invention adopts the following technical solution.

A mosquito-killing screen window includes a frame body and a mosquito-killing window sash. The mosquito-killing window sash is disposed in the frame body and can slide in the frame body. The inside of the frame body is fixedly provided with a first energizing part and the first energizing part is connected to a power source through a wire. The wire is disposed in the frame body. The mosquito-killing window sash is fixedly provided with a second energizing part. The second energizing part is connected to a mosquito-killing mesh of the mosquito-killing window sash. The first energizing part is matched with the second energizing part so that the first energizing part is communicated with the second energizing part when closing the mosquito-killing screen window.

Preferably, the first energizing part includes a first fixed block. A plug pin made of a conducting material is installed on the first fixed block. The plug pin is connected to the power source through a wire. The second energizing part includes a second fixed block. A jack made of a conducting material is disposed on the second fixed block. The jack is connected with the mosquito-killing mesh through a wire, and the plug pin is matched with the jack.

Preferably, the first energizing part includes a first fixed block. A jack made of a conducting material is installed on the first fixed block. The jack is connected to the power source through a wire. The second energizing part includes a second fixed block. A plug pin made of a conducting material is disposed on the second fixed block. The plug pin is connected with the mosquito-killing mesh through a wire, and the plug pin is matched with the jack.

Preferably, a magnetic sheet is disposed on the first fixed block, and a metal sheet attractive to the magnetic sheet is disposed on the second fixed block so that when the plug pin is inserted into the jack, a state of inserting the plug pin into the jack can be kept.

Or, the magnetic sheet is disposed on the second fixed block, and the metal sheet attractive to the magnetic sheet is disposed on the first fixed block so that when the plug pin is inserted into the jack, a state of inserting the plug pin into the jack can be kept.

Preferably, the inside of the plug pin is provided with a spring.

Preferably, the power source is a portable power source. A transformer is disposed between the portable power source and the first energizing part. The transformer is connected to the first energizing part through a wire, and the transformer is connected to the portable power source through a wire.

Preferably, the power source is an AC power source. A transformer is disposed between the AC power source and the first energizing part. The transformer is connected to the first energizing part through a wire, and the transformer is connected to the AC power source through a wire.

Preferably, the mosquito-killing screen window includes an anode mosquito-killing mesh and a cathode mosquito-killing mesh. An insulating frame is disposed between the anode mosquito-killing mesh and the cathode mosquito-killing mesh, and the anode mosquito-killing mesh and the cathode mosquito-killing mesh are connected to the plug pin through wires.

Preferably, the edges of the anode mosquito-killing mesh and the cathode mosquito-killing mesh of the mosquito-killing screen window are provided with insulated binding tapes.

Compared with the prior art, the mosquito-killing screen window provided by the present invention includes a frame body and a mosquito-killing window sash. The mosquito-killing window sash is disposed in the frame body and can slide in the frame body. The inside of the frame body is fixedly provided with the first energizing part and the first energizing part is connected to the power source through a wire. The wire is disposed in the frame body. The mosquito-killing window sash is fixedly provided with the second energizing part. The second energizing part is connected to the mosquito-killing mesh of the mosquito-killing window sash. The first energizing part is matched with the second energizing part so that the first energizing part is communicated with the second energizing part when closing the mosquito-killing screen window. Therefore, it does not need to worry that the power wire moves together with the screen window when opening and closing the screen window, which greatly increases the entire beauty of the mosquito-killing screen window. Meanwhile, the risks of damage and leakage of the wire in case of being constantly pushed and pulled are eliminated, so that the security is high. When the mosquito-killing screen window is opened, it is not energized, and when the mosquito-killing screen window is closed, it is energized; therefore, the mosquito-killing screen window is avoided being under an energizing state all the time, thus saving the energy.

### BRIEF DESCRIPTION OF THE DRAWINGS

In order to explain the technical solutions in the embodiments of the invention or in the related art more clearly, the drawings used in the descriptions of the embodiments or the related art will be simply introduced hereinafter. It is apparent that the drawings described hereinafter are merely some embodiments of the invention, and those skilled in the art may also obtain other drawings according to these drawings without going through creative work.

FIG. 1 is a structure schematic view of two window sashes of a mosquito-killing screen window;

FIG. 2 is a structure schematic view of a first energizing part and a second energizing part during two window sashes of the mosquito-killing screen window;

FIG. 3 is an exploded schematic view of the first energizing part and the second energizing part during two window sashes of the mosquito-killing screen window;

FIG. 4 is a structure schematic view of a single window sash of the mosquito-killing screen window;

FIG. 5 is a structure schematic view of a first energizing part and a second energizing part during single window sash of the mosquito-killing screen window; and

FIG. 6 is an exploded schematic view of the first energizing part and the second energizing part during single window sash of the mosquito-killing screen window.

### DETAILED DESCRIPTION

The core of the present invention is to provide a mosquito-killing screen window which is beautiful in entirety, has high security and can save energy. Further illustrative explanations will be made clearly and completely to the technical solutions in the embodiments of the invention hereinafter with reference to the accompanying drawings in the embodiments of the invention. Apparently, the embodiments described are merely partial embodiments of the present invention, rather than all embodiments. Other embodiments derive by those having ordinary skills in the art on the basis of the embodiments of the invention without going through creative efforts shall all fall within the protection scope of the present invention.

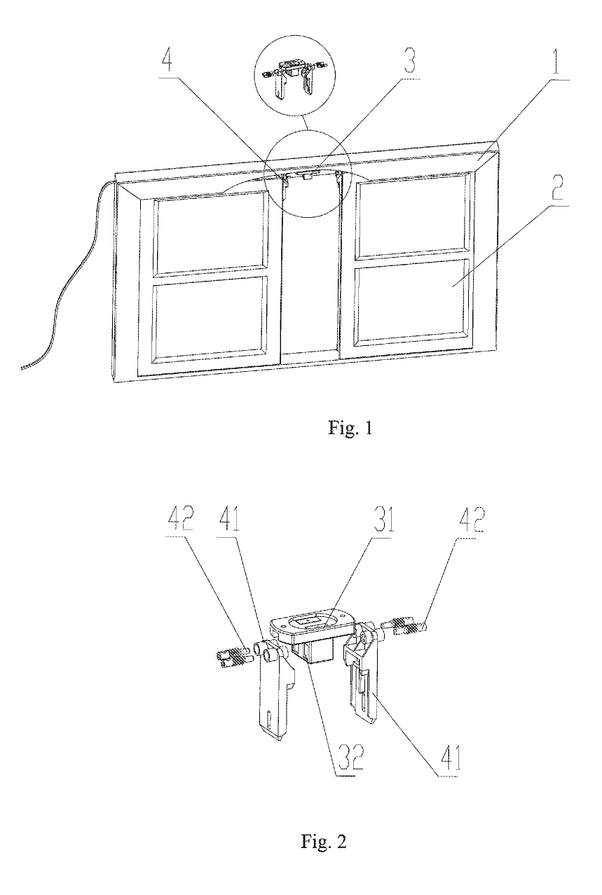

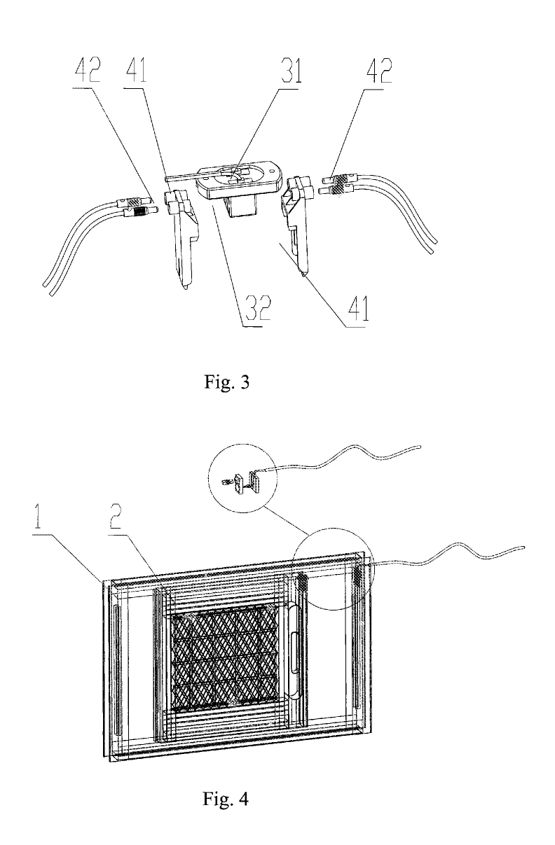

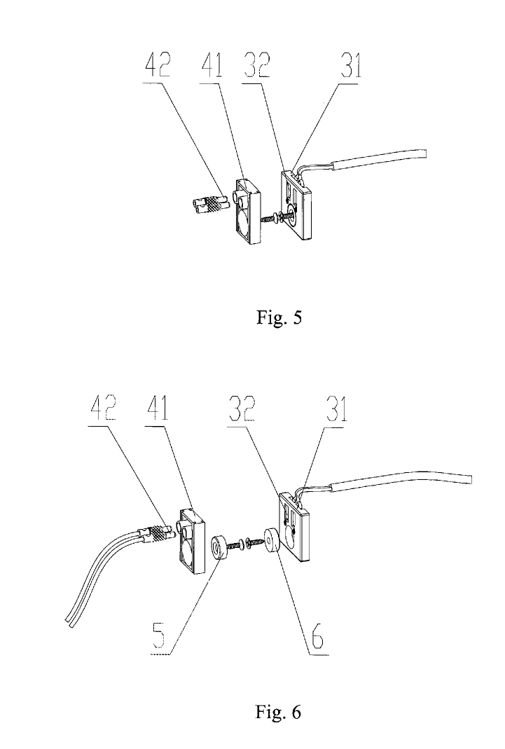

The embodiment provides a mosquito-killing screen window. As shown in FIG. 1 to FIG. 6, the mosquito-killing screen window provided by the embodiment includes a frame body 1 and a mosquito-killing window sash 2. The mosquito-killing window sash 2 is disposed in the frame body 1 and can slide in the frame body 1. The inside of the frame body 1 is fixedly provided with a first energizing part 3 and the first energizing part 3 is connected to a power source via a wire. The wire is disposed in the frame body 1. the mosquito-killing window sash 2 is fixedly provided with a second energizing part 4. The second energizing part 4 is connected to a mosquito-killing mesh 21 of the mosquito-killing window sash 2. The first energizing part 3 is matched with the second energizing part 4 so that the first energizing part 3 is communicated with the second energizing part 4 when closing the mosquito-killing screen window.

Compared with the prior art, the mosquito-killing screen window provided by the embodiment includes a frame body 1 and a mosquito-killing window sash 2. The mosquito-killing window sash 2 is disposed in the frame body 1 and can slide in the frame body 1. The inside of the frame body 1 is fixedly provided with a first energizing part 3 and the first energizing part 3 is connected to a power source via a wire. The wire is disposed in the frame body 1. the mosquito-killing window sash 2 is fixedly provided with a second energizing part 4. The second energizing part 4 is connected to a mosquito-killing mesh 21 of the mosquito-killing window sash 2. The first energizing part 3 is matched with the second energizing part 4 so that the first energizing part 3 is communicated with the second energizing part 4 when closing the mosquito-killing screen window. Therefore, it does not need to worry that the power wire moves together with the screen window when opening and closing the screen window, which greatly increases the entire beauty of the mosquito-killing screen window. Meanwhile, the risks of damage and leakage of the wire in case of being constantly pushed and pulled are eliminated, so that the security is high. When the mosquito-killing screen window is opened, it is not energized, and when the mosquito-killing screen window is closed, it is energized; therefore, the mosquito-killing screen window is avoided being under an energizing state all the time, thus saving the energy.

Wherein in the embodiment, the first energizing part 3 includes a first fixed block 31. A plug pin 32 made of a conducting material is installed on the first fixed block 31. The plug pin 32 is connected to the power source through a wire. The second energizing part 4 includes a second fixed block 41. A jack 42 made of a conducting material is disposed on the second fixed block 41. The jack 42 is connected to the mosquito-killing mesh 21 through a wire. The plug pin 32 is matched with the jack 42.

When the mosquito-killing screen window of the embodiment works, the mosquito-killing window sash 2 is pushed, so that the mosquito-killing window sash 2 slides in the frame body 1. When the mosquito-killing window sash is closed, the plug pin 32 is inserted into the jack 42. Since the plug pin 32 is connected to the power source through a wire, and the jack 42 is connected to the mosquito-killing mesh 21 through a wire, the mosquito-killing mesh 21 is energized when the mosquito-killing window sash 2 is closed, and the mosquito-killing mesh 21 starts working. Certainly, it can also be that the first energizing part 3 includes a first fixed block 31. A jack 42 made of a conducting material is disposed on the first fixed block 31. The jack 42 is connected to the power source through a wire. The second energizing part 4 includes a second fixed block 41. A plug pin 32 made of a conducting material is installed on the second fixed block 41. The jack 32 is connected to the mosquito-killing mesh 21 through a wire. The plug pin 32 is matched with the jack 42.

When the plug pin 32 is inserted into the jack 42, in order to keep a state of inserting the plug pin 32 into the jack 42, in the embodiment, the first fixed block 31 is provided with a magnetic sheet 5, and the second fixed block 41 is provided with a metal sheet 6 attractive to the magnetic sheet 5, so that when the plug pin 32 is inserted into the jack 42, the state of inserting the plug pin 32 into the jack 42 can be kept, thus increasing the contact stability between the plug pin 32 and the jack 42. Or,

the second fixed block 41 is provided with the magnetic sheet 5, and the first fixed block 41 is provided with the metal sheet 6 attractive to the magnetic sheet 5, so that when the plug pin 32 is inserted into the jack 42, the state of inserting the plug pin 32 into the jack 42 can be kept.

In the embodiment, in order to make the plug pin 32 and the jack 42 have a better combination effect, the inside of the plug pin 32 is provided with a spring.

The power source in the embodiment is a portable power source. A transformer is disposed between the portable power source and the first energizing part 3. The transformer is connected to the first energizing part 3 through a wire, and the transformer is connected to the portable power source through a wire.

The power source can also be an AC power source. A transformer is disposed between the portable power source and the first energizing part 3. The transformer is connected to the first energizing part 3 through a wire, and the transformer is connected to the AC power source through a wire.

The mosquito-killing screen window in the embodiment includes an anode mosquito-killing mesh and a cathode mosquito-killing mesh. An insulating frame is disposed between the anode mosquito-killing mesh and the cathode mosquito-killing mesh, and the anode mosquito-killing mesh and the cathode mosquito-killing mesh are connected to the plug pin through wires.

Wherein, the edges of the anode mosquito-killing mesh and the cathode mosquito-killing mesh of the mosquito-killing screen window are provided with insulated binding tapes.

When the embodiment provides one mosquito-killing window sash, the structure of the mosquito-killing screen window is as shown in FIG. 4 to FIG. 6. At this moment, the first fixed block 31 is installed on the side face of the frame body 1, and the second fixed block 41 is installed on one side of the mosquito-killing window sash 2 close to the second fixed block 41, so that the plug pin 32 can be inserted into the jack 42 when closing the mosquito-killing window sash.

When the embodiment provides two mosquito-killing window sashes, the structure of the mosquito-killing window sash is as shown in FIG. 1 to FIG. 3. At this moment, the first fixed blocks 31 are installed on the middle of the horizontal part of the frame body 1, and the second fixed blocks 41 are respectively installed on one sides of the two mosquito-killing window sashes 2 close to the second fixed blocks 41, so that the plug pin 32 can be inserted into the jack 42 when closing the mosquito-killing window sashes.

The mosquito-killing screen window provided by the embodiment not only can be used on a window, but also can be installed on a door.

The above descriptions on the disclosed embodiments enable those skilled in the art can realize or use the present invention. Various modifications on these embodiments are apparent for those skilled in the art, and general principles defined herein can be realized in other embodiments without departing from the spirit or scope of the present invention. Accordingly, the present invention will not be limited to these embodiments shown herein, but is to be accorded with the widest scope consistent with the principles and novel features disclosed herein.

1. A mosquito-killing screen window, comprising a frame body (1) and a mosquito-killing window sash (2), wherein the mosquito-killing window sash (2) is disposed in the frame body (1) and can slide in the frame body (1), the inside of the frame body (1) is fixedly provided with a first energizing part (3) and the first energizing part (3) is connected to a power source through a wire, the wire is disposed in the frame body (1), the mosquito-killing window sash (2) is fixedly provided with a second energizing part (4), the second energizing part (4) is connected to a mosquito-killing mesh (21) of the mosquito-killing window sash (2), and the first energizing part (3) is matched with the second energizing part (4) so that the first energizing part (3) is communicated with the second energizing part (4) when closing the mosquito-killing screen window.

2. The mosquito-killing screen window according to claim 1, wherein the first energizing part (3) comprises a first fixed block (31), a plug pin (32) made of a conducting material is installed on the first fixed block (31), the plug pin (32) is connected to the power source through a wire, the second energizing part (4) comprises a second fixed block (41), a jack (42) made of a conducting material is disposed on the second fixed block (41), the jack (42) is connected with the mosquito-killing mesh (21) through a wire, and the plug pin (32) is matched with the jack (42).

3. The mosquito-killing screen window according to claim 1, wherein the first energizing part comprises a first fixed block (31), a jack (42) made of a conducting material is disposed on the first fixed block (31), the plug pin (42) is connected to the power source through a wire, the second energizing part (4) comprises a second fixed block (41), a plug pin (32) made of a conducting material is installed on the second fixed block (41), the plug pin (32) is connected with the mosquito-killing mesh (21) through a wire, and the plug pin (32) is matched with the jack (42).

4. The mosquito-killing screen window according to claim 2, wherein a magnetic sheet (5) is disposed on the first fixed block (31), and a metal sheet (6) attractive to the magnetic sheet (5) is disposed on the second fixed block (41) so that when the plug pin (32) is inserted into the jack (42), a state of inserting the plug pin (32) into the jack (42) can be kept;
or, the magnetic sheet (5) is disposed on the second fixed block (41) and the metal sheet (6) attractive to the magnetic sheet (5) is disposed on the first fixed block (31) so that when the plug pin (32) is inserted into the jack (42), a state of inserting the plug pin (32) into the jack (42) can be kept.

5. The mosquito-killing screen window according to claim 4, wherein the inside of the plug pin (32) is provided with a spring.

6. The mosquito-killing screen window according to claim 5, wherein the power source is a portable power source, a transformer is disposed between the portable power source and the first energizing part (3), the transformer is connected to the first energizing part (3) through a wire, and the transformer is connected to the portable power source through a wire.

7. The mosquito-killing screen window according to claim 5, wherein the power source is an AC power source, a transformer is disposed between the AC power source and the first energizing part (3), the transformer is connected to the first energizing part (3) through a wire, and the transformer is connected to the AC power source through a wire.

8. The mosquito-killing screen window according to claim 5, wherein the mosquito-killing screen window comprises an anode mosquito-killing mesh and a cathode mosquito-killing mesh, an insulating frame is disposed between the anode mosquito-killing mesh and the cathode mosquito-killing mesh, and the anode mosquito-killing mesh and the cathode mosquito-killing mesh are connected to the plug pin through wires.

9. The mosquito-killing screen window according to claim 8, wherein the edges of the anode mosquito-killing mesh and the cathode mosquito-killing mesh of the mosquito-killing screen window are provided with insulated binding tapes.
